(19) United States
(12) Patent Application Publication
(10) Pub. No.: US 2003/0075205 A1
(43) Pub. Date: Apr. 24, 2003

(54) Toilet bowl soaker

(76) Inventor: Orin A. Roberson, Houston, TX (US)

Correspondence Address: Darcell Walker, 8107 Carvel Lane, Houston, TX, 77036, US

(21) Appl. No.: 09/981,039

(22) Filed: Oct. 17, 2001

Related U.S. Application Data
(60) Provisional application No. 60/241,025, filed on Oct. 17, 2000.

(51) Int. Cl. B08B 9/093

(52) U.S. Cl. 134/22.18; 134/166 R

(57) ABSTRACT

The present invention is a device that is to be inserted into a toilet bowl that will assist in the cleaning of the toilet bowl. The device is a hollow tube with a stopper at the lower end to cover the drain of the toilet bowl. As water enters the toilet bowl, the stopper causes the water to rise. Cleaning fluid in the water cleaning the surface of the toilet bowl as the water rises. The water will rise to the rim level of the toilet bowl and enable cleaning solution in the water to clean difficult to access areas of the bowl even around the rim of the toilet bowl. The device of the present invention is positioned in the toilet bowl such that the water does not overflow out of the toilet bowl.

### CROSS REFERENCE TO RELATED APPLICATIONS

This application relates to a provisional patent application, serial No. 60/241025, filed on Oct. 17, 2000 and which is incorporated herein by reference.

### FIELD OF THE INVENTION

The present invention refers to a simple low cost disposable method and system for cleaning toilet bowls. In particular, it refers to a cleaning apparatus that allows for the raising of the toilet bowl's fluid level by flushing the toilet, thus allowing for the removal of stains via soaking while automatically adding the proper amount of cleaning solution.

### BACKGROUND OF THE INVENTION

Cleaning a toilet bowl is an unpleasant task. Because of the design of the toilet bowl, it is often necessary to use brushes to clean up under the lip of the bowl. Also, the toilet bowl usually remains clean beneath the water line, but has the tendency to get rust, hard water and discoloration stains above the water line. In addition to the bowl not getting completely clean, cleaning of toilets is exasperated by the need to store a contaminated brush between uses. The user of a toilet brush is also subject to obvious medical hazards related to bacteria and contaminants in the toilet. This method is bad enough for toilets in private homes but is particularly troublesome for toilets in hospitals, hotels, and other commercial locations. Heretofore there have been no low cost sanitary means to adequately clean a toilet bowl.

### SUMMARY OF THE INVENTION

It is an objective of the present invention to provide a device that will enable a person to clean a toilet bowl more efficiently and thoroughly.

It is a second objective of the present invention to provide a device that can be inserted into a toilet bowl to assist in the cleaning of the toilet bowl.

It is a third objective of the present invention to provide a device that can be inserted into a toilet bowl that will enable the water in the toilet bowl to the level of the toilet bowl rim and thereby enable cleaning solution in the water to clean the rim of the toilet bowl.

It is a fourth objective of the present to provide a device that can enable a person to clean a toilet bowl and especially the toilet bowl rim without the use of brushes.

The present invention provides a device that can be used to assist in the cleaning of toilet bowls. The device comprises a hollow tube with a stopper at the lower end of the tube. The tube is designed to be inserted into the toilet bowl such that the stopper at the lower end of the tube covers the drain at the bottom of the toilet bowl. A cleaning solution can then be added to the water in the toilet bowl. As water is added to the toilet by flushing or physically adding water from an external source, the stopper will prevent the water from draining put of the bowl and thereby cause the water level to rise toward the top rim of the bowl. As the water rises the cleaning solution in the water will clean the surface of the toilet bowl. As the water reaches the rim of the bowl, the cleaning solution will also have access to and clean the rim of the toilet bowl. The toilet rim is often to completely clean with a conventional toilet bowl brush. The device is positioned in the toilet such that the rising water will eventually drain into the tube of the device and thereby prevent the overflow of the water out of the toilet bowl.

### DESCRIPTION OF THE DRAWINGS

FIG. 1 is a cross-section view of a conventional toilet bowl.

FIG. 2 is a view of the present invention inserted into a toilet bowl.

FIG. 3 illustrates the present invention positioned in a toilet bowl.

### DESCRIPTION OF THE INVENTION

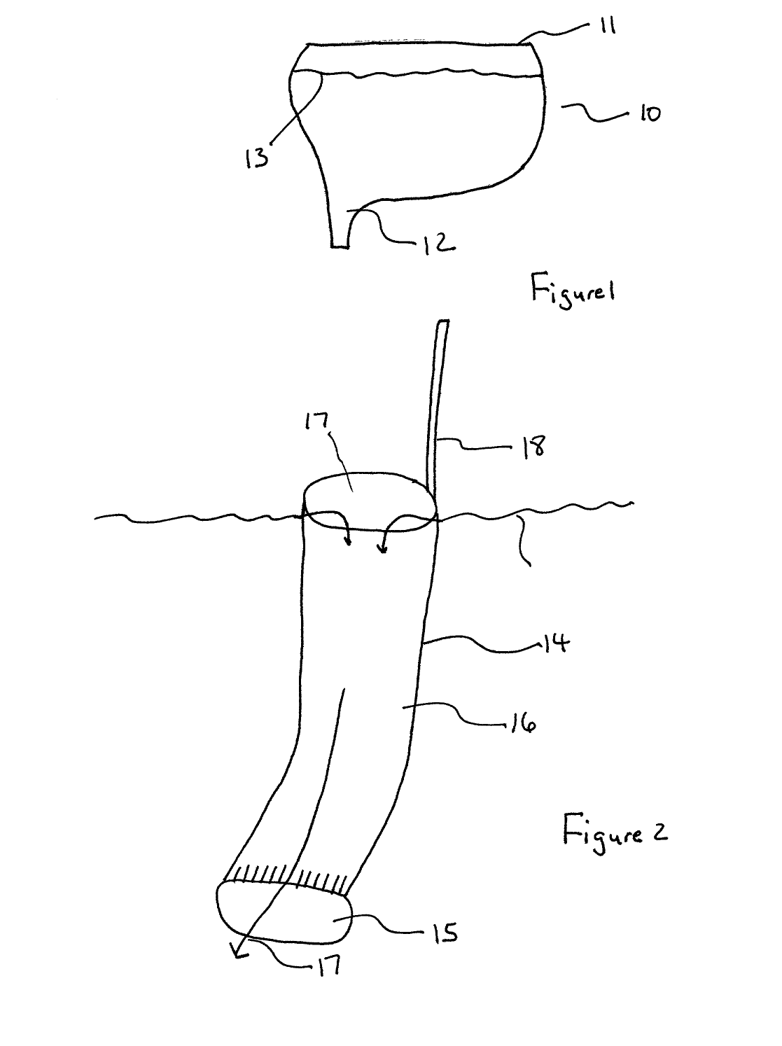

FIG. 1 shows a convention toilet bowl that is in use today. The toilet bowl 10 has a curved shape with a rim 11, and a drain 12. The toilet bowl is designed to contain water 13 to be used during the flushing process.

This invention 14 is a device that has a stopper 15 attached to its bottom end to stop the flow of fluid from the toilet bowl out through the outlet hole of the toilet. It also has a hollow tube 16 with an opening in the stopper 17 that allows the toilet's water to begin to automatically flow to the toilet's outlet drain once the water rises above the extent of the unit's tubing. The present invention is held in place by a wedge design hollow stopper. The unit can have a dispensing system that automatically dispenses cleaning/sanitizing fluids into the toilet bowl as the fluid in the container rises to the needed level. The invention can also be fitted with an optional reservoir for the cleaning/sanitizing or other solutions. The reservoir automatically delivers the correct concentrations of cleaning solutions as the water or primary fluid is being added to the toilet or other container. The unit's adjustable curvature is contoured to fit the toilet's natural curvatures.

The present invention also has an ergonomically designed handle 18 that allows the user to hold it comfortably as it is put into place. The handle also prevents the need for the user to reach into the toilet, thus preventing hand contamination. The invention can be equipped with an attached brush to be used for heavy stains. The invention can also have an adjustable ledge support for stabilizing and locking the unit in place when it is in use. The adjustable support system also affords the invention the ability to fit various designs to toilets.

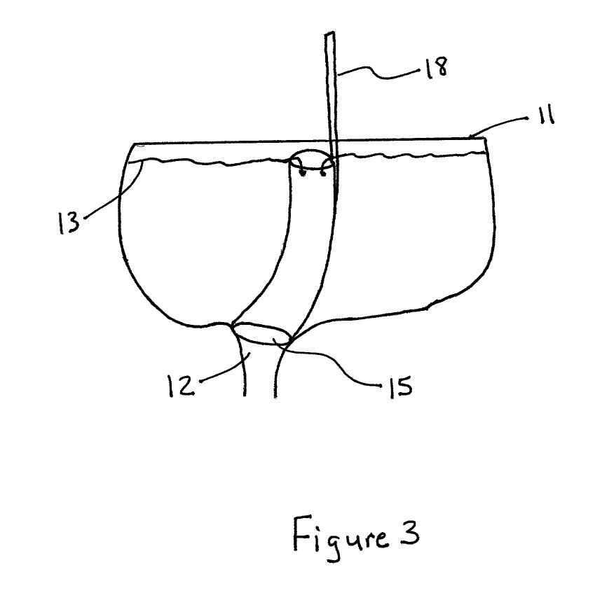

FIG. 3 illustrates the installation of the present invention in a toilet bowl. The lower end stopper 15 of the present invention covers the drain 12 of the toilet bowl. The handle 18 can assisted in the positioning of the device. As water 13, containing cleaning fluid, rises in the toilet bowl, the fluid cleans the surface of the toilet bowl. As the water reaches the rim 11 of the toilet bowl, the cleaning solution can access and clean the difficult places of the rim.

The invention can be used with current in-tank cleaning solutions. It can enhance the cleaning solution's ability to clean as more bowl surface has a chance to soak due to the elevated water level in the toilet bowl. The invention works in conjunction with tank mounted detergent disks, cleaning systems and the like. The water originating from the tank, containing the cleaning solution and manually added cleaning agents are assisted in cleaning by the present invention. The present invention is especially helpful when trying to clean difficult locations such as the area underneath the rim.

The water channel tube's height is adjustable to accommodate various toilet styles. The unit locks into place with utilizing a compressible seal that forces the unit to brace against the rim of the toilet or and a wedge designed stopper that wedges into the toilet drain hole to lock the unit in place. The rim lock is mounted at a higher level than the drain tube of the unit, ensuring that the rim of the toilet is higher than the drain tube. The user releases the water from the toilet by simply removing the unit and placing it into its optional holder. The present invention has a dedicated drain tube capable of handling the required water flow to prevent overflow.

The system allows for cleaning of the toilet or container by raising the level of the fluid in the container long enough for the cleaning solution to soak the stains away. The present invention performs this task with no contact with contamination and with little to no contact with chemical hazards from cleaning and other solutions. The prior art required the dissolving of tablets in the toilet reservoir, which kept the reservoir clean but not the bowl itself, or it was a brush that was used in an attempt to brush away stains that have set in the bowl. After spraying a cleaner that was designed to cling to the walls of the toilet, a brush would be used. That method required very close and potentially hazardous contact with the surface of the toilet.

Other similar inventions attempted to use water pressure to hold the unit in place and utilized the handle with a small orifice to channel the water. The present invention locks into place utilizing a compressible seal that when it expands after being compressed, forces the unit to brace against the rim of the toilet or and a wedge designed stopper that wedges into the toilet drain hole to lock the unit in place. The present invention has a dedicated drain tube capable of handling the required water flow to prevent overflow.

The device of this invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. A device for use in cleaning a toilet bowl comprising:
a flexible tube for insertion into a toilet bowl, said tube having an upper and a lower end, said upper end enabling water from the toilet bowl to flow into the tube to prevent water overflow out of the toilet bowl;
and a hollow center; and
a stopper attached to the lower end of the tube, said stopper capable of covering the drain of the toilet bowl to prevent water from flowing out of the toilet bowl.

2. The device as described in claim 1 further comprising a handle attached to the upper end of said tube, said handling enabling a user to further position and secure said tube in the toilet bowl.

3. The device as described in claim 1 wherein said stopper is a wedge stopper.

4. The device as described in claim 1 further comprising a reservoir containing cleaning solution, said reservoir being fitted to said tube.

5. The device as described in claim 1 wherein said tube has a shape contoured to fit a curvature shape of the toilet bowl's surface.

6. The device as described in claim 4 further comprising a means to dispense cleaning solution contained in said reservoir.

7. The device as described in claim 1 further comprising an attachable brush for use in cleaning heavy stains.

8. The device as described in claim 2 further comprising an adjustable ledge support for stabilizing and locking the device in place when in use in the toilet bowl.

9. The device of claim 1 wherein said tube has an adjustable length.

10. A method for cleaning stains from a toilet comprising the steps of:
sealing the drain of a toilet bowl such that the water does not drain out of the toilet bowl;
dispensing cleaning solution into the water in the toilet bowl; and
cleaning the surface of the toilet bowl with the cleaning solution dispensed in the water in the toilet bowl, said surface cleaning occurring as the water level is raised in the toilet bowl.

11. The method as described in claim 10 wherein said drain sealing step comprises inserting a tube device with a stopper attached to the lower end of the tube into the toilet bowl such that the stopper seals the toilet bowl drain.

12. The method as described claim 10 wherein said water level is raised during the cleaning process by inserting a tube with a stopper attached to the lower end of the into the toilet such that the stopper seals the toilet bowl drain, said insertion of the tube into the toilet bowl displaces the water and causes the water level to rise.

13. The method as described in claim 12 wherein said water level is also raised during the cleaning process by adding water to the water in the toilet bowl.

14. The method as described in claim 11 wherein said tube is inserted into the toilet bowl using a handle attached to the tube.

15. The method as described in claim 11 further comprising the steps of stabilizing and locking the tube in place in the toilet bowl drain.

16. The method as described in claim 15 further comprising the step of covering the toilet bowl with a lid during the cleaning process.
